(19) United States
(12) Patent Application Publication
(10) Pub. No.: US 2022/0165075 A1
(43) Pub. Date: May 26, 2022

(54) METHOD AND DEVICE FOR CLASSIFING DENSITIES OF CELLS, ELECTRONIC DEVICE USING METHOD, AND STORAGE MEDIUM

(71) Applicant: HON HAI PRECISION INDUSTRY CO., LTD., New Taipei (TW)

(72) Inventors: Wan-Jhen Lee, New Taipei (TW); Chin-Pin Kuo, New Taipei (TW); Chih-Te Lu, New Taipei (TW)

(21) Appl. No.: 17/533,394

(22) Filed: Nov. 23, 2021

(30) Foreign Application Priority Data
Nov. 26, 2020 (CN) 202011357231.X

(51) Int. Cl. G06V 20/69; G06V 10/82; G06V 10/74; G06V 10/774; G06V 10/776

(52) U.S. Cl. CPC G06V 20/698; G06V 10/82; G06V 10/776; G06V 10/774; G06V 10/761

(57) ABSTRACT

A method for classifying cells densities by cell images being input into artificial computer intelligence inputs an image of biological cells as a test image into one or more trained models of convolutional neural network until a reconstructed image of the biological cells generated by one trained model matches with the test image. Each of the trained models of the convolutional neural network corresponds to one certain density range in which cell densities of images of the biological cells are found. The method also determines that a cell density of the test image is within the density range corresponding to the trained model of the convolutional neural network for which the reconstructed image of the biological cells and the test image match. A related electronic device and a non-transitory storage medium are also disclosed.

### FIELD

The subject matter herein generally relates to artificial computer intelligence and particularly, to a method and a device for classifying cell densities, an electronic device using method, and a storage medium.

### BACKGROUND

To do research into biological cells, for example biological stem cells, an actual number and volume of the stem cells in an image may be not needed, but a range of densities of the stem cells in the image is needed. However, a biological cell counting method calculates a number and volume of the stem cells in the image, and calculates the range of densities of the stem cells in the image according to the number and the volume of the stem cells, this is very time consuming.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of an embodiment of a device for classifying cells densities.

FIG. 2 illustrates a block diagram of another embodiment of a device for classifying cells densities.

FIG. 3 illustrates a flowchart of an embodiment of a method for classifying cells densities.

FIG. 4 illustrates a flowchart of an embodiment describing a process for inputting an image of biological cells as a test image into one or more trained models of convolutional neural network until a reconstructed image of the biological cells generated by one trained model matches with the test image.

FIG. 5 illustrates a view of another embodiment showing a process for inputting a test image into one or more trained models of convolutional neural network until a reconstructed image of the biological cells generated by one trained model matches with the test image.

FIG. 6 illustrates a flowchart of another embodiment of a method for classifying cells densities.

FIG. 7 shows the inputting of trained images of the biological cells, each with a certain density range, into model of the convolutional neural network to generate a number of trained models of the convolutional neural network.

FIG. 8 illustrates a block diagram of an embodiment of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, referencing the accompanying drawings, is illustrated by way of examples and not by way of limitation. It should be noted that references to “an” or “one” embodiment in this disclosure are not necessarily to the same embodiment, and such references mean “at least one.”

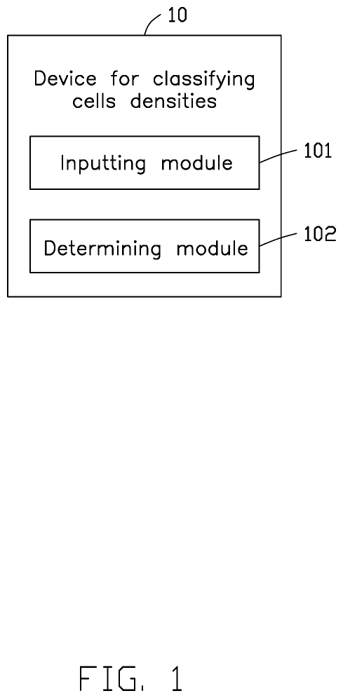

FIG. 1 illustrates a block diagram of an embodiment of a device for classifying cells densities. The device for classifying cells densities (hereinafter CCD device) 10 can be applied in an electronic device. The electronic device can be a smart phone, a desktop computer, a tablet computer, or the like. The CCD device 10 can include an inputting module 101 and a determining module 102. The inputting module 101 is configured to input an image of biological cells as a test image into one or more trained models of convolutional neural network until a reconstructed image of the biological cells generated by one trained model matches with the test image. Each trained model of the convolutional neural network corresponds to one certain density range in which cell densities of images of the biological cells are found. The determining module 102 is configured to determine that a cell density of the test image is within the density range corresponding to the trained model of the convolutional neural network for which the reconstructed image of the biological cells and the test image match.

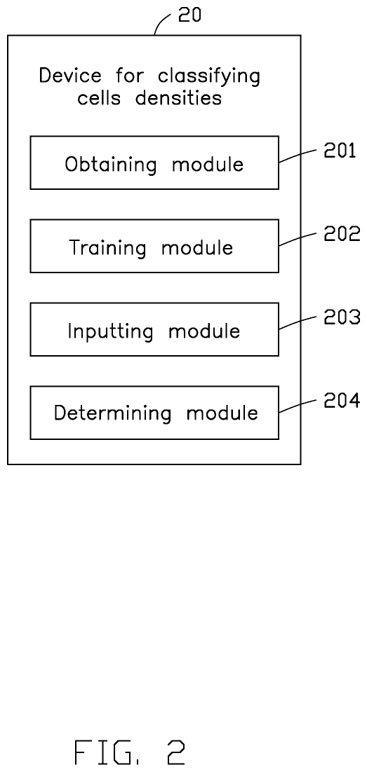

FIG. 2 illustrates a block diagram of another embodiment of a CCD device. The CCD device 20 can be applied in an electronic device. The electronic device can be a smart phone, a desktop computer, a tablet computer, or the like. The CCD device 20 can include an obtaining module 201, a training module 202, an inputting module 203, and a determining module 204. The obtaining module 201 is configured to obtain a number of training images of the biological cells divided into a number of different density ranges. The training module 202 is configured to input the training images of the biological cells each with a certain density range into corresponding model of the convolutional neural network to generate a number of trained models of the convolutional neural network. The inputting module 203 is configured to input an image of biological cells as a test image into one or more trained models of convolutional neural network until a reconstructed image of the biological cells generated by one trained model matches with the test image. Each trained model of the convolutional neural network corresponds to one density range in which cell densities of images of the biological cells are found. The determining module 204 is configured to determine that a cell density of the test image is within the density range corresponding to the trained model of the convolutional neural network for which the reconstructed image of the biological cells and the test image match.

Details of the functions of the modules 101˜102 and modules 201˜204 will be described with reference to a flowchart of a method for classifying cells densities.

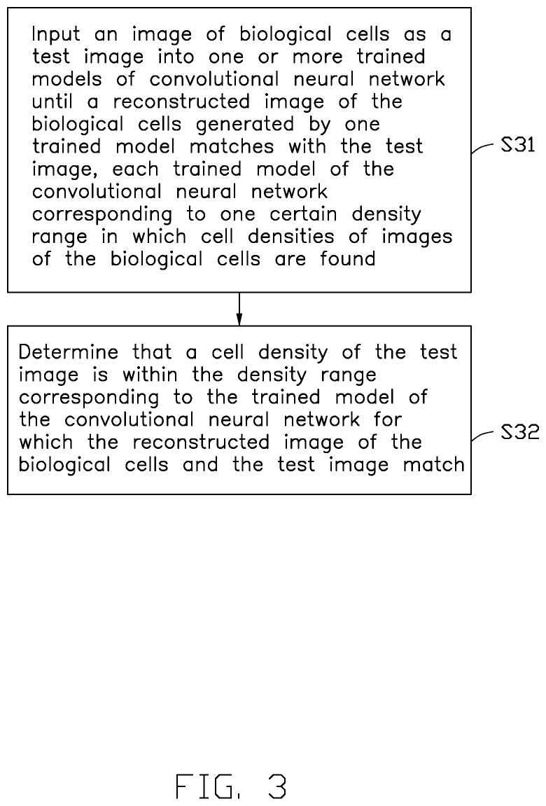

FIG. 3 is a flowchart of an embodiment of a method for classifying cells densities. The method for classifying cells densities can include the following:

At block S31, inputting an image of biological cells as a test image into one or more trained models of convolutional neural network until a reconstructed image of the biological cells generated by one trained model matches with the test image, each trained model of the convolutional neural network corresponding to one certain density range in which cell densities of images of the biological cells are found.

Each image of the biological cells can be, for example, an image of biological stem cells. The image of the biological stem cells includes stem cells and other substances. The other substances can be impurity or other cells. The cell density range of the reconstructed image of the biological cells is the same as the density range in which the cell densities of the images of the biological cells corresponding to the trained model of the convolutional neural network are found.

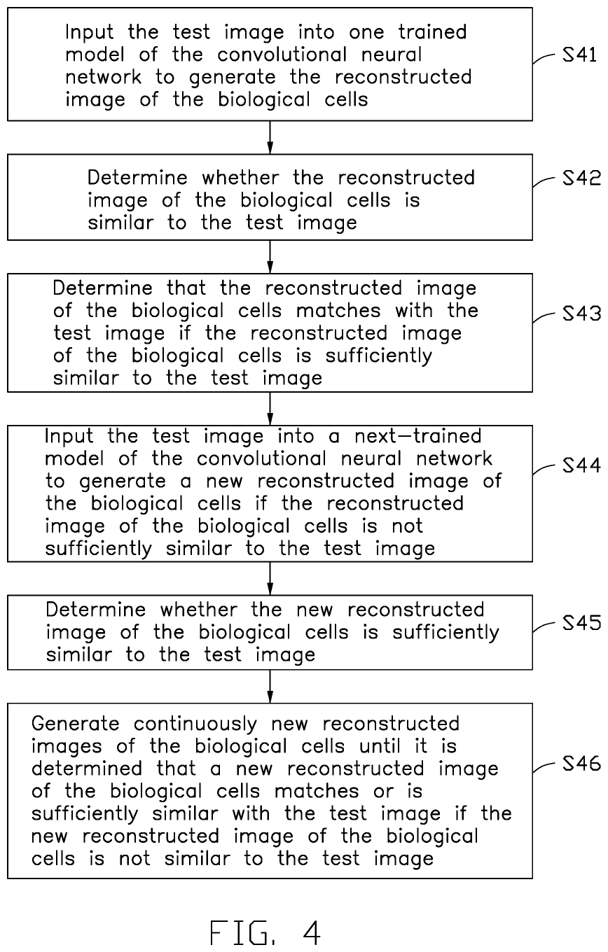

FIG. 4 illustrates a flowchart of an embodiment describing a process for inputting an image of biological cells as a test image into one or more trained models of convolutional neural network until a reconstructed image of the biological cells generated by one trained model matches with the test image. The flowchart can include the following:

At block S41, inputting the test image into one trained model of the convolutional neural network to generate the reconstructed image of the biological cells.

At block S42, determining whether the reconstructed image of the biological cells is similar to the test image.

At block S43, determining that the reconstructed image of the biological cells matches with the test image if the reconstructed image of the biological cells is sufficiently similar to the test image.

At block S44, inputting the test image into a next-trained model of the convolutional neural network to generate a new reconstructed image of the biological cells if the reconstructed image of the biological cells is not sufficiently similar to the test image.

At block S45, determining whether the new reconstructed image of the biological cells is sufficiently similar to the test image.

At block S46, generating continuously new reconstructed images of the biological cells until it is determined that a new reconstructed image of the biological cells matches or is sufficiently similar with the test image if the new reconstructed image of the biological cells is not similar to the test image.

For example, the method inputs a test image 1 of the biological cells into a trained model 1 of the convolutional neural network to generate a reconstructed image 1 of the biological cells. In the method, a determination is made as to whether the reconstructed image 1 of the biological cells is similar to the test image 1 of the biological cells, and the determination is that the reconstructed image 1 of the biological cells is not similar to the test image 1 of the biological cells. At that moment, the method further inputs the test image 1 of the biological cells into a trained model 2 of the convolutional neural network to generate a reconstructed image 2 of the biological cells, and determines whether the reconstructed image 2 of the biological cells is similar to the test image 1 of the biological cells. It may be determined that the reconstructed image 2 of the biological cells is sufficiently similar to the test image 1 of the biological cells. At that moment, the method determines that the reconstructed image 2 of the biological cells matches with the test image 1 of the biological cells.

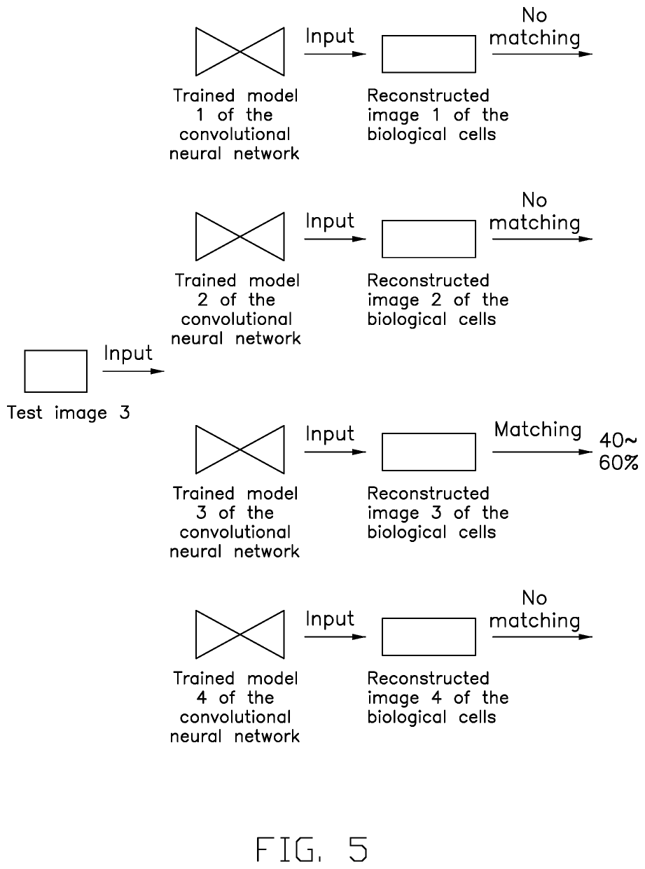

FIG. 5 illustrates a view of another embodiment showing a process for inputting a test image into one or more trained models of convolutional neural network until a reconstructed image of the biological cells generated by one trained model matches with the test image. In this embodiment, the test image is input into all trained models of convolutional neural network until a reconstructed image of the biological cells generated by one trained model matches with the test image. In FIG. 5, the test image 3 is input into a trained model 1 of the convolutional neural network, a trained model 2 of the convolutional neural network, a trained model 3 of the convolutional neural network, and a trained model 4 of the convolutional neural network. Thereby, and respectively, a reconstructed image 1 of the biological cells is generated, a reconstructed image 2 of the biological cells is generated, a reconstructed image 3 of the biological cells is generated, and a reconstructed image 4 of the biological cells is generated. The reconstructed image 3 of the biological cells is found to match with the test image 3.

At block S32, determining that a cell density of the test image is within the density range corresponding to the trained model of the convolutional neural network for which the reconstructed image of the biological cells and the test image match.

Determining that a cell density of the test image is within the density range corresponding to the trained model of the convolutional neural network for which the reconstructed image of the biological cells and the test image match, can be, for example, as shown FIG. 5. In the FIG. 5, the reconstructed image 3 of the biological cells generated by the trained model 3 of the convolutional neural network matches with the test image 3, thus the method determines that the cell density of the test image 3 is within the density range (say from 40% to 60%), corresponding to the trained model 3 of the convolutional neural network.

The method inputs an image of biological cells as a test image into one or more trained models of convolutional neural network until a reconstructed image of the biological cells generated by one trained model matches with the test image. Each trained model of the convolutional neural network corresponds to one density range in which cell densities of images of the biological cells are found, and the method determines that a cell density of the test image is within the density range corresponding to the trained model of the convolutional neural network for which the reconstructed image of the biological cells and the test image match. Thus, in this disclosure, the trained model of the convolutional neural network is used to determine the cell density of the test image of the biological cells, with no need to calculate the number and the volume of the cells, improving a speed of counting cells.

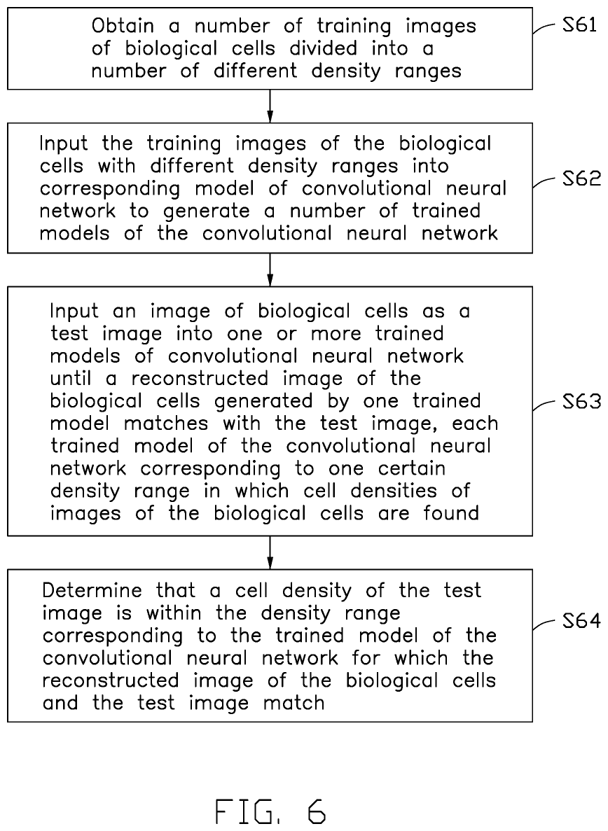

FIG. 6 is a flowchart of another embodiment of a method for classifying cells densities. The method for classifying cells densities can include the following:

At block S61, obtaining a number of training images of biological cells divided into a number of different density ranges.

A density range formed by the number of different density ranges may be from zero to 100%. A uniformity of the densities within each density range can be totally uniform or less than totally uniform.

The obtaining of a number of training images of biological cells divided into a number of different density ranges can include a step a1 and a step a2. The step a1 includes obtaining the number of training images of the biological cells. The step a2 includes dividing the number of the training images into training images of biological cells with different density ranges.

The division of the number of the training images into density-range classes can be according to a preset regulation or randomly.

At block S62, inputting the training images of the biological cells with different density-range classes into corresponding model of convolutional neural network to generate a number of trained models of the convolutional neural network.

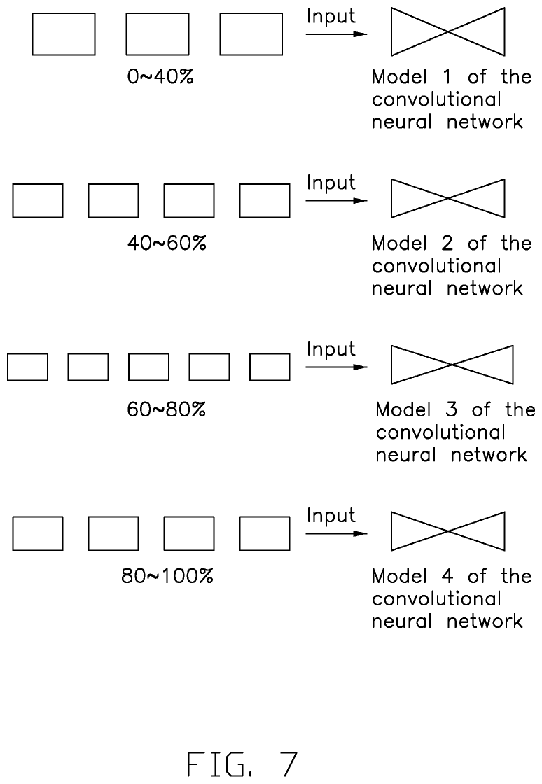

The inputting of the training images of the biological cells with different density-range classes into corresponding model of convolutional neural network to generate a number of trained models of the convolutional neural network can be, for example, as shown in FIG. 7, inputting the training images of the biological cells with a density range from zero to 40% into a model 1 of the convolutional neural network, inputting the training images of the biological cells with a density range from 40% to 60% into a model 2 of the convolutional neural network, inputting the training images of the biological cells with a density range from 60% to 80% into a model 3 of the convolutional neural network, and inputting the training images of the biological cells with a density range from 80% to 100% into a model 4 of the convolutional neural network. Thereby, and respectively, a trained model 1 of the convolutional neural network is generated, a trained model 2 of the convolutional neural network is generated, a trained model 3 of the convolutional neural network is generated, and a trained model 4 of the convolutional neural network is generated.

At block S63, inputting an image of the biological cells as a test image into one or more trained models of the convolutional neural network until a reconstructed image of the biological cells generated by one trained model matches with the test image, each trained model of the convolutional neural network corresponding to one certain density range (one class) in which cell densities of images of the biological cells are found.

The block S63 is the same as the block S31, details thereof are as the description of the block S31, which will not be repeated.

At block S64, determining that a cell density of the test image is within the density range corresponding to the trained model of the convolutional neural network for which the reconstructed image of the biological cells and the test image match.

The block S64 is the same as the block S32, details thereof are as the description of the block S32, which will not be repeated.

The method obtains a number of training images of biological cells divided into a number of different density ranges, and inputs the training images of the biological cells with different density ranges into corresponding model of convolutional neural network to generate a number of trained models of the convolutional neural network. A test image is input into one or more trained models of the convolutional neural network until a reconstructed image of the biological cells generated by one trained model matches with the test image, and a determination can be made that a cell density of the test image is within the density range corresponding to the trained model of the convolutional neural network for which the reconstructed image of the biological cells and the test image match. Thus, a number of models of the convolutional neural network are trained, and the trained models of the convolutional neural network are used to determine the cell density of the test image of the biological cells, with no need to calculate the number and the volume of the cells, improving a speed of counting cells.

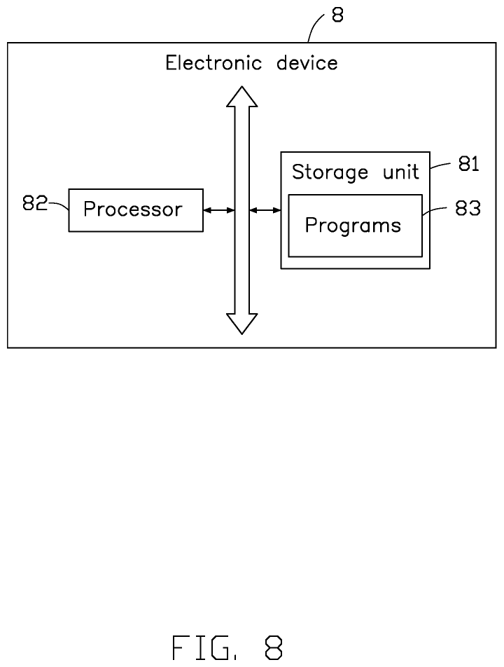

FIG. 8 illustrates a block diagram of an embodiment of an electronic device. The electronic device 8 can include a storage unit 81, at least one processor 82, and one or more programs 83 stored in the storage unit 81 which can be run on the at least one processor 82. The at least one processor 82 can execute the one or more programs 83 to accomplish the steps of the exemplary method. Or the at least one processor 82 can execute the one or more programs 83 to accomplish the functions of the modules of the exemplary device.

The one or more programs 83 can be divided into one or more modules/units. The one or more modules/units can be stored in the storage unit 81 and executed by the at least one processor 82 to accomplish the disclosed purpose. The one or more modules/units can be a series of program command segments which can perform specific functions, and the command segment is configured to describe the execution process of the one or more programs 83 in the electronic device 8. For example, the one or more programs 83 can be divided into modules as shown in the FIG. 1 and the FIG. 2, the functions of each module are as described above.

The electronic device 8 can be any suitable electronic device, for example, a personal computer, a tablet computer, a mobile phone, a PDA, or the like. A person skilled in the art knows that the device in FIG. 8 is only an example and is not to be considered as limiting of the electronic device 8, another electronic device 8 may include more or fewer parts than the diagram, or may combine certain parts, or include different parts, such as more buses, and so on.

The at least one processor 82 can be one or more central processing units, or it can be one or more other universal processors, digital signal processors, application specific integrated circuits, field-programmable gate arrays, or other programmable logic devices, discrete gate or transistor logic, discrete hardware components, and so on. The at least one processor 82 can be a microprocessor or the at least one processor 82 can be any regular processor or the like. The at least one processor 82 can be a control center of the electronic device 8, using a variety of interfaces and lines to connect various parts of the entire electronic device 8.

The storage unit 81 stores the one or more programs 83 and/or modules/units. The at least one processor 82 can run or execute the one or more programs and/or modules/units stored in the storage unit 81, call out the data stored in the storage unit 81 and accomplish the various functions of the electronic device 8. The storage unit 81 may include a program area and a data area. The program area can store an operating system, and applications that are required for the at least one function, such as sound or image playback features, and so on. The data area can store data created according to the use of the electronic device 8, such as audio data, and so on. In addition, the storage unit 81 can include a non-transitory storage medium, such as hard disk, memory, plug-in hard disk, smart media card, secure digital, flash card, at least one disk storage device, flash memory, or another non-transitory storage medium.

If the integrated module/unit of the electronic device 8 is implemented in the form of or by means of a software functional unit and is sold or used as an independent product, all parts of the integrated module/unit of the electronic device 8 may be stored in a computer-readable storage medium. The electronic device 8 can use one or more programs to control the related hardware to accomplish all parts of the method of this disclosure. The one or more programs can be stored in a computer-readable storage medium. The one or more programs can apply the exemplary method when executed by the at least one processor. The one or more stored programs can include program code. The program code can be in the form of source code, object code, executable code file, or in some intermediate form. The computer-readable storage medium may include any entity or device capable of recording and carrying the program codes, recording media, USB flash disk, mobile hard disk, disk, computer-readable storage medium, and read-only memory.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for classifying cells densities comprising:
inputting an image of biological cells as a test image into one or more trained models of convolutional neural network until a reconstructed image of the biological cells generated by one trained model matches with the test image, each of the trained models of the convolutional neural network corresponding to one certain density range in which cell densities of images of the biological cells are found;
determining that a cell density of the test image is within the density range corresponding to the trained model of the convolutional neural network for which the reconstructed image of the biological cells and the test image match.

2. The method according to claim 1, wherein before inputting an image of biological cells as a test image into one or more trained models of convolutional neural network until a reconstructed image of the biological cells generated by one trained model matches with the test image, the method further comprises:
obtaining a plurality of training images of the biological cells divided into a plurality of different density ranges;
inputting the training images of the biological cells with different density ranges into corresponding model of the convolutional neural network to generate a plurality of trained models of the convolutional neural network.

3. The method according to claim 2, wherein:
a density range formed by the plurality of different density ranges is from zero to 100%.

4. The method according to claim 2, wherein the obtaining a plurality of training images of the biological cells divided into a plurality of different density ranges comprises:
obtaining the plurality of training images of the biological cells;
dividing the plurality of the training images of the biological cells into training images of biological cells with different density ranges.

5. The method according to claim 1, wherein the inputting an image of biological cells as a test image into one or more trained models of convolutional neural network until a reconstructed image of the biological cells generated by one trained model matches with the test image comprises:
inputting the test image into one trained model of the convolutional neural network to generate the reconstructed image of the biological cells;
determining whether the reconstructed image of the biological cells is similar to the test image;
determining that the reconstructed image of the biological cells matches with the test image if the reconstructed image of the biological cells is similar to the test image.

6. The method according to claim 5, wherein the method further comprises:
inputting the test image into a next-trained model of the convolutional neural network to generate a new reconstructed image of the biological cells if the reconstructed image of the biological cells is not similar to the test image;
determining whether the new reconstructed image of the biological cells is similar to the test image;
generating continuously new reconstructed images of the biological cells until it is that a new reconstructed image of the biological cells matches with the test image if the new reconstructed image of the biological cells is not similar to the test image.

7. The method according to claim 1, wherein:
a cell density range of the reconstructed image of the biological cells is the same as the density range in which the cell densities of the images of the biological cells corresponding to the trained model of the convolutional neural network are found.

8. An electronic device comprising:
a storage device;
at least one processor; and
the storage device storing one or more programs, which when executed by the at least one processor, cause the at least one processor to:
input an image of biological cells as a test image into one or more trained models of convolutional neural network until a reconstructed image of the biological cells generated by one trained model matches with the test image, each of the trained models of the convolutional neural network corresponding to one certain density range in which cell densities of images of the biological cells are found;
determine that a cell density of the test image is within the density range corresponding to the trained model of the convolutional neural network for which the reconstructed image of the biological cells and the test image match.

9. The electronic device according to claim 8, further causing the at least one processor to:
obtain a plurality of training images of the biological cells divided into a plurality of different density ranges;
input the training images of the biological cells with different density ranges into corresponding model of the convolutional neural network to generate a plurality of trained models of the convolutional neural network.

10. The electronic device according to claim 9, wherein:
a density range formed by the plurality of different density ranges is from zero to 100%.

11. The electronic device according to claim 9, further causing the at least one processor to:
obtain the plurality of training images of the biological cells;
divide the plurality of the training images of the biological cells into training images of biological cells with different density ranges.

12. The electronic device according to claim 8, further causing the at least one processor to:
input the test image into one trained model of the convolutional neural network to generate the reconstructed image of the biological cells;
determine whether the reconstructed image of the biological cells is similar to the test image;
determine that the reconstructed image of the biological cells matches with the test image if the reconstructed image of the biological cells is similar to the test image.

13. The electronic device according to claim 12, further causing the at least one processor to:
input the test image into a next-trained model of the convolutional neural network to generate a new reconstructed image of the biological cells if the reconstructed image of the biological cells is not similar to the test image;
determine whether the new reconstructed image of the biological cells is similar to the test image;
generate continuously new reconstructed images of the biological cells until it is that a new reconstructed image of the biological cells matches with the test image if the new reconstructed image of the biological cells is not similar to the test image.

14. The electronic device according to claim 8, wherein:
a cell density range of the reconstructed image of the biological cells is the same as the density range in which the cell densities of the images of the biological cells corresponding to the trained model of the convolutional neural network are found.

15. A non-transitory storage medium storing a set of commands, when the commands being executed by at least one processor of an electronic device, causing the at least one processor to:
input an image of biological cells as a test image into one or more trained models of convolutional neural network until a reconstructed image of the biological cells generated by one trained model matches with the test image, each of the trained models of the convolutional neural network corresponding to one certain density range in which cell densities of images of the biological cells are found;
determine that a cell density of the test image is within the density range corresponding to the trained model of the convolutional neural network for which the reconstructed image of the biological cells and the test image match.

16. The non-transitory storage medium according to claim 15, further causing the at least one processor to:
obtain a plurality of training images of the biological cells divided into a plurality of different density ranges;
input the training images of the biological cells with different density ranges into corresponding model of the convolutional neural network to generate a plurality of trained models of the convolutional neural network.

17. The non-transitory storage medium according to claim 16, wherein:
a density range formed by the plurality of different density ranges is from zero to 100%.

18. The non-transitory storage medium according to claim 16, further causing the at least one processor to:
obtain the plurality of training images of the biological cells;
divide the plurality of the training images of the biological cells into training images of biological cells with different density ranges.

19. The non-transitory storage medium according to claim 15, further causing the at least one processor to:
input the test image into one trained model of the convolutional neural network to generate the reconstructed image of the biological cells;
determine whether the reconstructed image of the biological cells is similar to the test image;
determine that the reconstructed image of the biological cells matches with the test image if the reconstructed image of the biological cells is similar to the test image.

20. The non-transitory storage medium according to claim 19, further causing the at least one processor to:
input the test image into a next-trained model of the convolutional neural network to generate a new reconstructed image of the biological cells if the reconstructed image of the biological cells is not similar to the test image;
determine whether the new reconstructed image of the biological cells is similar to the test image;
generate continuously new reconstructed images of the biological cells until it is that a new reconstructed image of the biological cells matches with the test image if the new reconstructed image of the biological cells is not similar to the test image.
